(19) United States
(12) Patent Application Publication
(10) Pub. No.: US 2014/0272062 A1
(43) Pub. Date: Sep. 18, 2014

(54) MACHINE AND MUDDLER FOR MUDDLING INGREDIENTS OF A BEVERAGE, AND METHOD OF OPERATION

(71) Applicant: Braxton P. Hogan, Laguna Niguel, CA (US)

(72) Inventor: Braxton P. Hogan, Laguna Niguel, CA (US)

(21) Appl. No.: 14/204,706

(22) Filed: Mar. 11, 2014

Related U.S. Application Data
(60) Provisional application No. 61/792,967, filed on Mar. 15, 2013.

(51) Int. Cl. A47J 43/044

(52) U.S. Cl. CPC A47J 43/044
USPC 426/519; 99/287

(57) ABSTRACT

Muddler machines and methods for muddling ingredients of a beverage in a container. The machine includes a muddler having at least one head. A drive assembly is attached to the upper end of the muddler for rotating reciprocatively and moving the muddler extensively away from the drive assembly to advance the muddler head within the container and into engagement with the ingredients therein. The drive assembly rotates the muddler about its axis through a given rotation for mashing the ingredients. The drive assembly then rotates reciprocatively and retracts the muddler.

### RELATED APPLICATION

This application claims priority to U.S. provisional patent application, entitled MACHINE AND METHOD FOR MUDDLING INGREDIENTS OF A BEVERAGE, Application No. 61/792,967, filed Mar. 15, 2013.

### FIELD OF THE INVENTION

The present invention relates in general to a machine and method for muddling ingredients of a beverage, and it more particularly relates to a new and improved technique for facilitating the creation of muddled drinks.

### BACKGROUND OF THE INVENTION

There is no admission that the background art disclosed in this section legally constitutes prior art.

There have been a number of different drinks, both alcoholic and non-alcoholic, which have fruit or other edible organic products usually added for flavor. There have been a variety of different types and kinds of machines and devices for creating these beverages. For example, reference may be made to the following patents and patent applications: U.S. Pat. Nos. 2,285,113; 2,774,579; 6,056,206; U.S. design Pat. D531851S; D533019; D623485; and published U.S. patent applications 2007/0211562; 2007/0286016; 2008/0282722; 2011/0041348; 2011/0235462.

In the case of muddled drinks, such as Caipirinha Mint Juleps, Tom Collins, Mojitos and the like, they have typically been created utilizing a manual technique of using a manual muddler to mash ingredients such as a mint leaf to better infuse the flavor of the mint leaf into the beverage being created.

Modernly, many of the muddled drinks are served by bartenders at commercial establishments. Such manual techniques for making muddled drinks are time consuming and thus detracts from the efficiency of a busy bartender. Also, there cannot always be uniform consistency from one muddled drink to the next, even by the same bartender due to the manual operation involved.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a pictorial view of a muddling machine constructed in accordance with an embodiment;

FIG. 2 is a pictorial view of the muddling machine of FIG. 1, illustrated from a slightly different perspective;

FIG. 3 is a right side view of the muddling machine of FIG. 1; and

FIGS. 4A-B illustrate a pictorial view of a muddler and a head assembly constructed in accordance with an embodiment.

### DETAILED DESCRIPTION OF CERTAIN EMBODIMENTS

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the system, components and method of the present invention, as represented in the drawings, is not intended to limit the scope of the invention, as claimed, but is merely representative of the embodiment of the invention.

According to an embodiment, there is provided a machine, a muddler and a method for muddling ingredients of a beverage in a container. The machine includes a muddler having at least one head. A drive assembly is attached to the upper end of the muddler for rotating reciprocatively and moving the muddler extensively away from the drive assembly to advance the muddler head within the container and into engagement with the ingredients therein. The drive assembly rotates the muddler about its axis through a given rotation for mashing the ingredients. The drive assembly then rotates reciprocatively and retracts the muddler.

According to another embodiment, there is provided a cam and a cam follower to facilitate the movement of the muddler head downwardly into the container and then rotating it through a given rotation followed by retracting the head upwardly within the container. The muddler may include a plurality of angularly extending heads and the muddler head may include a group of flexible fingers. The machine may further include a stand for supporting the drive assembly which may include an electric motor. The machine may also include one or more actuators for activating the machine for one or more cycles of operation. The drive assembly may retract the muddler head upwardly after mashing the ingredients and may retract the muddler away from the mashed ingredients to at least momentarily stopping the mashing operation.

A further embodiment relates to a method of muddling ingredients of a beverage in a container, and includes moving a muddler extensively downwardly away from a drive assembly into the container to advance the muddler head within the container and forcibly into engagement with the ingredients therein; rotating the muddler about its axis through a given rotation for mashing the ingredients; and retracting the muddler. The method may further include selectively and automatically performing one or more cycles of operation.

According to yet another embodiment, there is provided a muddler having an elongated shaft, and one or more angularly disposed heads at one end of the shaft. The head includes a group of flexible projections which enable the ingredients to be mashed and still retain them within the container.

Referring now to the drawings, and more particularly to FIGS. 1, 2, 3 and 4, there is shown a machine 10 for muddling ingredients of a beverage in an open top container 19 (FIG. 3). The muddling machine 10 includes a stand 11 adapted to be supported from below on a support surface such as a table or bar (not shown). A muddler 12 is supported in an upright position by the stand 11 and includes a shaft 13 having at its bottom end a pair of angularly disposed heads 14 and 16 to form a head assembly generally indicated at 17 for mashing the ingredients such as mint leaves at the bottom of the container 19. The container 19 may rest on a base 20 of the stand 11 and be releasably secured in position by a generally C-shaped container holder 22 which extends in a horizontal disposition from the stand 11.

A drive assembly 18 is mounted and supported by the stand 11 to drive the muddler 12 as hereinafter described in greater detail. As best seen in FIGS. 3 and 4, the drive assembly 18 includes a downwardly depending motor drive shaft 21 which extends through a bearing sleeve 23 on the underside of the drive assembly 18. It should be understood that the drive assembly 18 includes an electrical motor 24 within the housing of the drive assembly 18 and has the downwardly extending drive shaft 21. Also, within the housing of the drive assembly 18 there is disposed a cylinder such as a solenoid for moving the shaft 21 upwardly and downwardly while the motor rotates the shaft 21. The end of the motor shaft 21 is fixed to the upper end of the muddler shaft 13.

A fixed sleeve 25 surrounds telescopically the muddler shaft 13 and is fixed to the stand 11 by a suitable releasable mounting support bracket 27 so that when the motor drives the shaft 21 and the solenoid moves the shaft upwardly and downwardly in an axial direction, the fixed sleeve 25 does not rotate or otherwise move due to the mounting support bracket shown in FIGS. 2 and 3 of the drawings. The fixed sleeve 25 may be connected to a head portion 43 of the stand 11 with a fixed support 44.

As best seen in FIGS. 3 and 4, a cam follower surface 29 is configured at the top end of the fixed sleeve 25 to cooperate with a roller cam 32 mounted at the upper end of the muddler shaft 13. In so doing, when the drive assembly 18 activates the muddler 12, the roller cam 32 follows the cam follower surface 29 on the top edge of the fixed sleeve 25 to cause the muddler 12 to move downwardly extensively away from the drive assembly 18 to advance the muddler head such as the head 14 or the head 16 within the container 19 and into engagement with the ingredients (not shown) therein. The drive assembly 18 then continues to rotate the muddler 12 about its axis through a given rotation for mashing the ingredients. For example, the muddler 12 may rotate through a quarter turn of 90 degrees or greater (such as 180 degrees). Thereafter, the drive assembly 18 retracts the muddler 12 upwardly toward the drive assembly 18. Thus, the muddler head 14 or 16 or heads 14 and 16 are driven reciprocatively upwardly and downwardly as the head 14 or 16 or heads 14 and 16 rotate.

If more than one cycle of operation is desired, the drive assembly 18 then repeats the cycle of operation by then moving the muddler 12 extensively away from the drive assembly and back down into the container 19 until the muddler head 14 or 16 or heads 14 and 16 within the container engage the ingredients for mashing them a second time. This operation can be repeated any number of times under the control of the bartender or other user. This motion of the muddler 12 of advancing downwardly, rotating through a given rotation and then continuing upwardly to repeat the cycle of operation is schematically indicated by the arrows 34 as shown in FIG. 2.

As shown in FIGS. 1 and 2, in order to enable the bartender or other user to control the number of repeated mashings of the ingredients, there is provided a series of buttons or other actuators, such as the buttons 36, 38 and 41, which when pushed or touched determines the number of cycles of operation. When the button 36 is activated, only one cycle is caused to occur before terminating the operation. When the button 38 is activated, three cycles of operation occur, and when the button 41 is activated, five cycles of operation are undertaken. After the desired number of cycles of operation are completed, the drive assembly 18 is automatically deactivated. In this manner, a busy bartender can select the amount of muddling to occur for a given drink by merely pressing a button, and then the bartender is free to provide other services while the machine 10 performs the operation. Since the operation is always performed by the machine 10 in the same manner, the drinks are all made consistently and uniformly. It is understood that other embodiments make include more or less actuators relating to performing a selected number of cycle(s), or other operations. For example, other actuator(s) may be used to selectively perform an operation such as juicing fruits or vegetables for beverages, for single serving or more quantities.

A head portion 43 of the stand 11 supports the drive assembly 18 and has the buttons 36, 38 and 41 mounted on its front face plate. An on-off switch 45 on the upper portion of the drive assembly 18 may be activated manually to turn on or off the machine 10. The drive assembly 18 may be battery operated from, example, either single-use or rechargeable batteries, or preferably, may include a power cable 26 connected to the head portion of the stand 11 for coupling the drive assembly 18 to a suitable source of alternating current.

As indicated in FIG. 4A, the muddler 12 with its drive assembly 18 may be removable from the stand 11 and used in a handheld operation. The user can grasp the drive assembly 18 or the sleeve 25 in one hand to perform substantially the same operation with the muddler 12 as described above for the operation of the machine 10.

As shown in FIG. 4B, the head assembly 17 is removable from the muddler shaft 13 for cleaning purposes and for ease of replacement. Each head is rounded and has a group of projections or fingers such as finger 47 composed of flexible rubber, Nylon®, or the like resilient material. The heads 14 and 16 are each disposed at an angle to the central axis of the muddler shaft 13. It should be understood that there may be any number of such heads, either fixed to or removable from, the shaft 13.

It should also be understood that the muddler 12 may be separated from the shaft 21 and the sleeve 25 to be used alternatively manually.

Certain advantages of automating the muddling process include:

1. Ability to produce more muddled drinks, which generate more profit compared to beer or standard mixed drinks.

2. Sanitary advantages (no lacquer shavings in drink, no glass chips transferred into the drink, no cuts of glass that can cut a finger and contaminate the drink).

3. Reduction of bar employee injuries (tendinitis, injuries from cut glasses due to muddling, etc.)

4. A more consistent process that does not under ordinary circumstances under-muddle or over-muddle the key ingredients of each drink.

### Description of Operation

The muddling machine 10 may muddle the core ingredients of a Mojito, Caipirinha, Mint Julep, Tom Collins and many others. The machine 10 may deliver a downward motion under suitable downward pressure to engage the ingredients in the container 19, and then rotate a given rotation such as a quarter turn or 90 degrees at the bottom of the downward motion. This motion may be performed by simply pushing a button on the machine 10. The bartender can either hold the container 19 such as a mixing cup under the muddling machine 10 or perform the operation unassisted by placing the mixing cup container 19 in the container holder 22. The machine 10 may shut off automatically after the operation is performed.

It is presently contemplated that the muddling machine 10 may employ an 8-10 inch long muddler 12 made out of stainless steel, with a rubber or Nylon “masher” that is food safe and germ resistant. The muddler 12 may also be detachable so it can be washed for sanitary reasons or replaced.

Presently desirable dimensions and materials include:

1. Height and width of machine 10: preferably a similar height as a liquor bottle;

2. Sufficient size to accommodate a conventional mixing cup;

3. Length of muddler 12: approximately 12 inches;

4. Muddler 12 may be removable for sanitary purposes;

5. Muddler heads 14 and 16: May comprise a nylon or rubber masher at the end of muddler 12, or other flexible material may be used;

6. May have multiple muddlers 12, for example may have two, three or four muddlers 12 for the same machine 10.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. A machine for muddling ingredients of a beverage in a container, comprising:
a muddler having at least one head;
drive assembly attached to the upper end of the muddler for rotating reciprocatively and moving the muddler extensively away from the drive assembly to advance the muddler head within the container and into engagement with the ingredients therein;
the drive assembly for rotating the muddler about its axis through a given rotation for mashing the ingredients; and
the drive assembly for rotating reciprocatively and retracting the muddler.

2. A machine according to claim 1, further including a cam and cam follower.

3. A machine according to claim 1, wherein the muddler includes a plurality of angularly extending heads.

4. A machine according to claim 1, wherein the muddler head includes a group of flexible fingers.

5. A machine according to claim 1, further including a stand for supporting the drive assembly.

6. A machine according to claim 1, wherein the drive assembly includes an electric motor.

7. A machine according to claim 1, further including one or more actuators for activating the machine for one or more cycles of operation.

8. A method of muddling ingredients of a beverage in a container, comprising:
moving a muddler extensively downwardly away from a drive assembly into the container to advance the muddler head within the container and forcibly into engagement with the ingredients therein;
rotating the muddler about its axis through a given rotation for mashing the ingredients; and
retracting the muddler.

9. A method according to claim 8, further including selectively and automatically performing one or more cycles of operation.

10. A muddler for muddling ingredients of a beverage in a container, comprising
an elongated shaft having a plurality of angularly disposed heads disposed at one end of the shaft.

11. A muddler according to claim 10, wherein each one of the heads includes a group of flexible projections.

12. A machine according to claim 1, wherein the drive assembly retracts the muddler head upwardly after mashing the ingredients.

13. A method according to claim 8, further including providing one or more muddlers each having one or more heads.

14. A machine according to claim 12, wherein the drive assembly retracts the muddler away from the mashed ingredients to at least momentarily stopping the mashing operation.
